(19) United States
(12) Patent Application Publication
(10) Pub. No.: US 2025/0230765 A1
(43) Pub. Date: Jul. 17, 2025

(54) Method for Operating an Internal Combustion Engine, Internal Combustion Engine and Control Device

(71) Applicant: KEYOU GmbH, München (DE)

(72) Inventors: Thomas Ebert, Wien (AT); Hiren Tala, Germering (DE); Gidion Maniezki, Eltville am Rhein (DE)

(21) Appl. No.: 18/690,365

(22) PCT Filed: Sep. 12, 2022
(86) PCT No.: PCT/EP2022/075199

§ 371 Date: Mar. 8, 2024

(30) Foreign Application Priority Data
Sep. 10, 2021 (DE) 10 2021 123 461.1

(51) Int. Cl. F02B 43/12; F02B 23/10; F02B 31/00

(52) U.S. Cl. CPC F02B 43/12; F02B 23/10; F02B 31/00

(57) ABSTRACT

Provided is a method for operating an internal combustion engine which includes at least one cylinder with a combustion chamber in which hydrogen fuel is combusted with air. In the combustion chamber, at least a flow of the hydrogen, at least in sections, carries out a rotational movement about at least one axis perpendicular to a longitudinal axis of the at least one cylinder. In order to provide a hydrogen/air mixture as homogeneous as possible which allows for low-emission and efficient combustion, the rotational movement of the flow about the axis perpendicular to the longitudinal axis of the at least one cylinder is induced by feeding in of the hydrogen.

### CROSS-REFERENCE TO RELATED APPLICATIONS

This application is the United States national phase of International Application No. PCT/EP2022/075199 filed Sep. 12, 2022, and claims priority to German Patent Application No. 10 2021 123 461.1 filed Sep. 10, 2021, the disclosures of each of which are hereby incorporated by reference in their entireties.

### BACKGROUND OF THE INVENTION

### Field of the Invention

The present invention relates to a method for operating an internal combustion engine, an internal combustion engine and a control device.

### Description of Related Art

Due to its environmentally friendly combustion together with air, hydrogen is a suitable fuel for approximately emission-free combustion engines.

At the same time, hydrogen fuel also poses problems. Due to its easy ignitability, there is a risk of misfiring, which adversely affects the combustion process and thus also the driving behavior in a vehicle equipped with a hydrogen-powered combustion engine.

DE 10 2006 029 754 A1 discloses an internal combustion engine in which a combustion gas can carry out a rotational movement in a recess of a piston.

Document WO 2020/249277 A1 discloses a method for a hydrogen-powered internal combustion engine, wherein a rotational flow of the fed in air, for example a tumble flow, is formed in a combustion chamber. WO 2020/249277 A1 aims to improve the auto-ignition properties in order to ensure good combustion. However, there is also a need to improve the combustion behavior of the method disclosed in WO 2020/249277 A1.

### SUMMARY OF THE INVENTION

It is therefore the object of the present invention to provide a hydrogen/air mixture as homogeneous as possible, which permits low-emission and efficient combustion.

This problem is solved according to the invention by a method for operating an internal combustion engine as described herein.

According to one aspect of the invention, a method is provided for operating an internal combustion engine comprising at least one cylinder with a combustion chamber in which hydrogen as fuel is combusted with air, wherein, in the combustion chamber, at least a flow of the hydrogen, at least in sections, carries out a rotational movement about at least one axis perpendicular to a longitudinal axis of the at least one cylinder. Furthermore, the rotational movement of the flow about the at least one axis perpendicular to the longitudinal axis of the at least one cylinder is induced by feeding in of the hydrogen.

According to the aspect, the hydrogen is thus fed in to the combustion chamber such that a flow with a rotational movement about at least one axis perpendicular to a longitudinal axis of the at least one cylinder, also referred to as tumble flow, is formed there at least in sections. This allows improved mixing with the air fed in to the combustion chamber, which results in a more homogeneous hydrogen/air mixture, as the hydrogen can be reliably conveyed towards the center of the combustion chamber due to the rotational movement about the axis perpendicular to the longitudinal axis. Whereas in the prior art the relatively heavy air surrounds the light hydrogen, which makes combustion and mixing with the air more difficult to control, according to the invention, the hydrogen can disperse into the air in the combustion chamber.

In this context, in particular at least the hydrogen fed in can itself carry out said rotational movement about at least the axis perpendicular to the longitudinal axis of the at least one cylinder, at least in sections.

This rotation allows the hydrogen to mix even better with the air.

According to a further aspect, in the method, the hydrogen can be fed in directly into the combustion chamber of the at least one cylinder.

It is therefore not necessary for the air flow to form a tumble flow, which is favorable for mixture formation. Furthermore, misfiring outside the combustion chamber can be prevented.

Preferably, the air flow carries out a rotational movement about the longitudinal axis at least in sections and at least temporarily in the combustion chamber; in particular preferably, the rotational movement about the longitudinal axis is preferably induced by the feeding in of air into the combustion chamber.

With the present invention, even in internal combustion engines in which the feeding in of air into the combustion chamber induces a rotational movement about the longitudinal axis (also referred to as swirl flow) in the combustion chamber, for example by design of the inlet geometry, a tumble flow of at least the hydrogen can be generated. Furthermore, due to the swirl flow, a negative pressure is present in a center of the combustion chamber in a vicinity of the longitudinal axis, which favors the formation of the tumble flow. The swirl flow is preferably reduced in the compression stroke of a piston that bounds the combustion chamber.

According to yet another aspect, the flow, preferably at least one jet emerging from a feeding device for feeding in the hydrogen, of the fed in hydrogen can impinge at least in sections on at least one surface section, further preferably of a combustion chamber boundary, again preferably on a cylinder inner wall of the at least one cylinder and/or on a surface of a piston bounding the combustion chamber. In particular preferably, at least the flow of hydrogen can be deflected at least in sections, again preferably in a plurality of directions.

The surface section can thus serve as a baffle plate on which the outlet jet of the feeding device can impinge. In this case, a flow deflection can in particular occur, which can favor the development of the rotational movement. If an outer combustion chamber boundary is used as a surface section, no further parts need to be provided. Furthermore, the flow of hydrogen can thus be provided at least in sections on an outer section of the combustion chamber and then reach the inside of the combustion chamber as a result of the rotational movement, which can improve mixing with the air. A position at which the flow impinges on the surface section is preferably on a side close to the piston with respect to an outlet of the feeding device, thus below an outlet of a feeding device for feeding the hydrogen in a gravitational direction when the cylinder is aligned along the gravitational direction. As a result, the piston can be reliably used to generate the rotational movement about the axis perpendicular to the center axis.

It is also preferable that the flow, in particular the outlet jet, impinges on the at least one surface section at an angle of greater than or equal to 0° and less than or equal to 50°, again preferably greater than or equal to 10° and less than or equal to 40°, in relation to the longitudinal axis. Thus, the flow can be reliably deflected in a plurality of directions. In particular, an axis of an outlet of the feeding device can intersect the longitudinal axis in said angular range.

Preferably, a surface section is located within a distance from an outlet of a feeding device of the hydrogen, wherein the distance is greater than or equal to 0.9 times and less than or equal to 1.2 times a stroke length of the piston bounding the combustion chamber, further preferably greater than or equal to one and less than or equal to 1.1 times the stroke length, in particular preferably greater than or equal to 1.06 times and less than or equal to 1.08 times the stroke length.

In particular, the jet emerging from the feeding device impinges on the surface section at this distance.

If the distance is dimensioned too large, the flow of the fed in hydrogen may reach the surface section with reduced momentum due to the pressure in the combustion chamber, which opposes the flow. This distance depends on the piston stroke. The relationship specified above can ensure that the fed in hydrogen reliably reaches the surface section, while at the same time ensuring a sufficient path for mixing.

In particular, this can be a long-stroke type internal combustion engine, where the stroke length is greater than the diameter of the cylinder bore.

According to yet another aspect, at least the flow of the fed in hydrogen can be guided at least in sections along at least a cylinder inner wall. Here too, the surface section is part of a combustion chamber boundary. As a result, the induction of the tumble by a wall guide can be controlled more reliably. In particular, the wall guide can take place following the impingement of the hydrogen flow on the at least one surface section. Preferably, the flow is guided along a plurality of surface sections, in particular through the inner wall of the cylinder and a surface of the piston facing the combustion chamber, and/or along a plurality of directions. In this way, mixing can be promoted throughout the entire combustion chamber.

According to yet another aspect, a surface of a piston bounding the combustion chamber can have a concave section, and preferably a flow of the fed in hydrogen impinges on the concave section at least in sections.

In this case, the concave section can be used to form the tumble of the flow of the fed in hydrogen. In particular, the hydrogen flow can impinge on the concave section and then be guided along the concave section, at least in sections.

According to yet another aspect, at least one surface section, preferably the concave section, comprises a rounded section. If the flow is guided along the rounded section, a rotational movement of the flow can be reliably initiated.

According to yet another aspect, the flow of hydrogen can impinge at least in sections from a point in time, preferably at least at this point in time, on at least one surface section at which the combustion chamber is closed and a quantity of air intended for the air/hydrogen mixture to be combusted is located completely in the combustion chamber.

Alternatively or additionally, the hydrogen can be fed in to the combustion chamber from this point in time, preferably at least at this point in time.

In this way, disturbance of the tumble flow by inflowing air can be reduced, preferably completely prevented. In addition, the hydrogen does not have to remain in the combustion chamber for too long, which reduces the risk of misfiring. Re-ignition in a feed pipe for feeding in the air can also be prevented. A sufficiently long mixing period can also be provided.

According to yet another aspect, the internal combustion engine can be spark-ignited. Good mixture homogenization is preferred, particularly in spark-ignited internal combustion engines that have a spark plug, for example.

Preferably, the rotational movement of the flow about the at least one axis perpendicular to the longitudinal axis of the at least one cylinder is present at least at the time of the start of ignition and further preferably at an ignition device. Further preferably, the rotational movement about the at least one axis perpendicular to the longitudinal axis of the at least one cylinder is present substantially throughout the entire combustion chamber during compaction. Thus, the method according to the invention is particularly suitable for homogeneous operation.

The rotational movement can achieve good mixture homogenization at the time of ignition, wherein an appropriately mixed mixture should be present at the ignition device in particular in order to ensure low-emission and efficient combustion. Furthermore, the rotational movement can be used to forward the flame front in the combustion chamber.

According to yet another aspect, a jet of the fed in hydrogen can have an opening angle of maximum 25°, preferably maximum 20°.

This allows momentum to be directed in a focused manner onto at least one surface section, which improves flow deflection and subsequent mixing.

According to yet another aspect, the flow of hydrogen can, at least in sections and at least temporarily, impinge on at least one surface section in a compression stroke, preferably between 180° and 80°, further preferably between 180° and 90°, again preferably between 170° and 120°, crank angle before a top dead center of a piston bounding the combustion chamber.

Alternatively or additionally, the hydrogen can be fed in at least temporarily during this period.

Preferably, the hydrogen impinges on at least one surface section over the entire specified period and/or is fed in over the entire period.

This can also ensure that the air in the mixture is already completely located in the combustion chamber, thereby reducing the effects caused by the inflow of air. Furthermore, the hydrogen can be given enough time to flow through the combustion chamber in order to achieve good mixing. Likewise, the hydrogen does not have to remain in the combustion chamber for too long. Preferably, at least one surface section, for example a piston surface section, is within the distance specified above at the time of the aforementioned crank angle range. This ensures that the hydrogen flow reliably impinges on the surface section.

According to yet another aspect, the internal combustion engine can have a feeding device for feeding in the hydrogen, which has at least one movable section that is movable with respect to the combustion chamber.

Thus, for example, a jet can be directed to different surface sections, which promotes mixing. It is also possible to react to different pressure conditions in different power ranges and, for example, direct the jet to a more distant surface section when the internal cylinder pressure is lower.

Preferably, the movable section is movable with at least one component parallel to a direction of movement of a piston bounding the combustion chamber in a direction away from the piston, and again preferably at least the movable section is preloaded along this direction.

With this configuration, at least the movable section can be arranged close to the surface section on which the hydrogen flow is to impinge, so that the surface section is reliably reached by the hydrogen flow. After the start of the feeding process, the movable section can then be moved away from the piston to make room for it. In particular, the movable section can be arranged at least in sections below a top dead center of the piston, at least at the start of the feeding process.

According to yet another aspect, the internal combustion engine is a conventional diesel internal combustion engine. The compression ratio is preferably between 9:1 and 13:1. Furthermore, the maximum final compression pressure of the internal combustion engine is preferably between 60 and 120 bar, more preferably between 80 and 100 bar.

As already described above, according to the above method, in a conventional diesel engine, in which a swirling movement of the air flow about a longitudinal cylinder axis usually occurs and which is configured to be self-igniting, a tumble flow for better mixing can be achieved when operating with hydrogen.

The present invention thus also relates to the use of a diesel internal combustion engine configured such that a flow of air carries out a rotational movement about a longitudinal cylinder axis in the combustion chamber, for carrying out the above method. In this case, the diesel internal combustion engine is converted in particular by attaching an ignition device.

The feeding device is also preferably configured so that it can feed in the hydrogen to the combustion chamber at a supply pressure of at least twice the internal cylinder pressure at the time the hydrogen is fed in. In particular, the hydrogen can be fed in to the combustion chamber at a maximum pressure of 50 bar, preferably a maximum of 30 bar. This means that the requirement for the feeding device can be reduced.

A further aspect of the invention provides an internal combustion engine which is configured so as to be operable according to the method according to one of the preceding claims. In particular, the internal combustion engine may comprise at least one of the structural features defined above.

In this way, an internal combustion engine can be provided that allows the method described above to be carried out.

According to the present invention, there is further provided a system, preferably a vehicle, comprising a storage device, such as a tank, for storing hydrogen and said internal combustion engine, wherein the storage device is coupled to the internal combustion engine for feeding in of the hydrogen.

According to yet another aspect, a control device is provided which is configured to carry out the method described above on an internal combustion engine. In particular, the control device can control the components of the internal combustion engine in order to carry out the method described above.

Further provided is a program that, when executed by a computer coupled to an internal combustion engine, carries out the method described above.

A computer-readable storage medium is also provided on which the program just described is stored.

### BRIEF DESCRIPTION OF THE DRAWINGS

Aspects of the invention are described in more detail with reference to the accompanying drawings.

FIG. 1 shows a section through an internal combustion engine at a time when hydrogen is fed in to a combustion chamber.

FIG. 2 also shows a section through an internal combustion engine, wherein a plurality of jets are shown as examples of jets impinging on a surface section.

### DESCRIPTION OF THE INVENTION

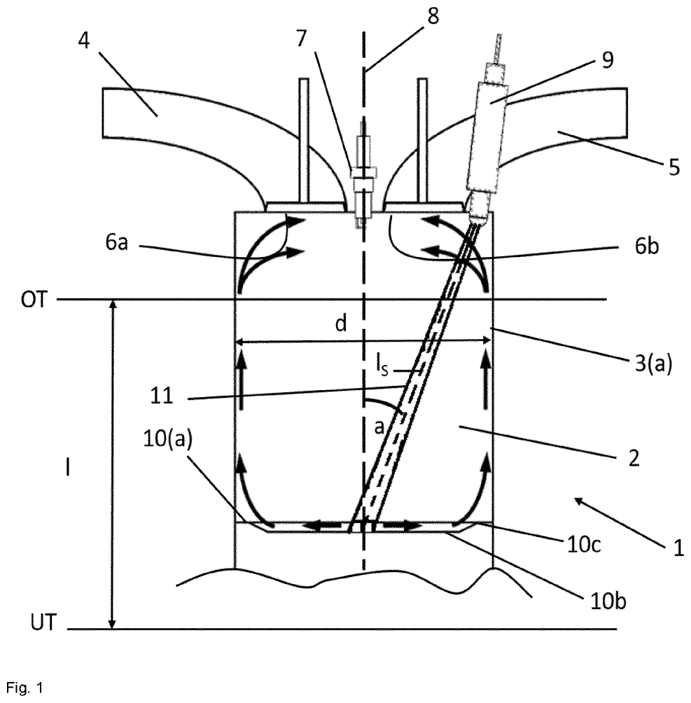

FIG. 1 shows an internal combustion engine 1 (motor), which is shown in FIG. 1 in a longitudinal sectional view along an axis of a combustion chamber 2 of a cylinder 3. In addition to the combustion chamber 2, the internal combustion engine 1 has a feed pipe 4 for feeding in air into the combustion chamber 2 and a discharge pipe 5 for discharging a burnt hydrogen/air mixture, which are each connected to the combustion chamber in a fluid-communicating manner via an inlet and outlet 6a and 6b, which are opened and closed respectively via valves. Preferably, only hydrogen is burned as fuel in the combustion chamber 2.

At an upper end, the combustion chamber 2 is closed by a cylinder head in which a spark plug 7 is arranged to ignite the hydrogen/air mixture. The spark plug is an example of an ignition device. The spark plug is arranged essentially at a position on a center axis 8 of the cylinder 3, in particular coaxially thereto.

Furthermore, the internal combustion engine 1 has a feeding device 9 that feeds in hydrogen directly to the combustion chamber 2. The feeding device 9 can be an injection nozzle, for example, and is preferably attached to the cylinder head. A section of the feeding device 9, which has an outlet, protrudes into the combustion chamber 2.

Opposite the inlet 6a with respect to the center axis 8 or the ignition device 7, there are the outlet 6b and also the feeding device 9, which is arranged further out from the center axis 8 with respect to the outlet 6b. The feeding device is preferably located on an outside of the combustion chamber 2, as is the case here.

At the lower end, the combustion chamber 2 is closed by a piston 10, which is rotatably coupled to a crankshaft (not shown). The piston 10 moves reciprocally up and down in the cylinder 3 between a top dead center TDC and a bottom dead center BDC in the cylinder along the center axis 8. A distance between TDC and BDC is referred to as I. On a surface 10a facing the combustion chamber 2, which is an upper planar surface, the piston 10 has a concave section 10b.

The combustion chamber 2 is laterally bounded by a cylinder inner wall 3a.

The cylinder 3 or combustion chamber 2 has an internal diameter d.

FIG. 1 shows the internal combustion engine in a state in which both the inlet 6a and the outlet 6b are closed by the respective valves. In addition, the piston 10 is in an upward movement to top dead center TDC in the compression stroke. The combustion chamber is therefore closed, wherein a quantity of air for combustion is already in the combustion chamber 2.

Furthermore, FIG. 1 shows an outlet jet 11 that emerges from the hydrogen feeding device 9 into the combustion chamber. In this case, the jet 11 is aligned so that it first impinges on the concave section 10b of the piston 10 at a position corresponding to the center axis 8.

As can be seen in FIG. 1, the jet 11 has a slight widening, preferably an opening angle of maximum 25°, with which it impinges on the concave section 10b. One axis of the jet impinges on the surface of the concave section at an angle a with respect to the center axis 8, which is preferably between 0° and 50°.

As can further be seen in FIG. 1, the concave section 10b acts as a baffle plate that deflects the flow of hydrogen, which is initially present as a focused jet 11. The hydrogen is therefore fed in such that the hydrogen flow is deflected.

In this case, as in FIG. 1, the jet is preferably deflected in a plurality of directions. The direction of flow of the hydrogen is indicated by arrows in FIG. 1. Starting from a single focused jet 11, the hydrogen is divided into different directions. The plurality of directions preferably comprise opposite directions, as can be seen in the longitudinal section along the longitudinal axis 8 of FIG. 1.

Downstream of the position at which the jet 11 impinges on the concave section 10b, the hydrogen flow is preferably guided through the concave section 10b along one surface thereof.

As shown in FIG. 1, the hydrogen is preferably guided towards the cylinder inner wall 3a, for example up to a peripheral section 10c of the piston surface 10a, in this case a peripheral section of the concave section 10b. The piston surface 10a, in particular the peripheral section 10c, have a deflection section that continues to deflect the flow in a guided manner, in FIG. 1 towards the cylinder inner wall 3a with a movement component (velocity component) in the upward direction, that is, in the direction of the cylinder head.

Preferably, the flow therefore performs a movement away from the piston 10 towards the ignition device 7, at least in sections, for example guided by the cylinder inner wall 3a and the deflector section. In the process, the flow is preferably guided beyond the top dead center towards the cylinder head in a direction away from the piston 10.

The deflection section can preferably be rounded. As indicated in FIG. 1, a rotational movement is thereby imposed on the flow, which continues due to the conservation of angular momentum.

The rotational movement runs about at least one axis, which in FIG. 1 points into the plane of the drawing, thus running perpendicular to the center axis 8. However, the rotational movement is not induced solely by the deflection section. Rather, at the point where the jet 11 impinges on the concave section 10b, an accumulation area is created that forces the flow to rotate. This can occur at any transition between non-coplanar or discontinuous surface sections, such as between the piston surface 10a and the cylinder inner wall 3a.

The rotational movement is induced in particular in sections of the hydrogen flow that are not in direct contact with the surface sections, thus in areas remote from the boundary layer, in particular in sections closer to the inside of the combustion chamber.

Furthermore, in particular in an area near the spark plug 7 or in an area around the center axis 8, thus a center of the combustion chamber 2, a negative pressure can be present, which imposes a rotational movement on the flow into the interior in the direction of the center axis 8, as also shown in FIG. 1.

As can be seen in FIG. 1, the hydrogen flow can enclose the air in the interior and preferably flows along a circumferential direction of the combustion chamber 2. At least in a section of the combustion chamber close to the cylinder head, the hydrogen flow flows into the interior of the combustion chamber.

Preferred effects of the invention are now described.

As shown in FIG. 1, a jet 11 of the fed in hydrogen emerging from a feeding device 9 impinges on a surface section that bounds the combustion chamber, namely the concave section 10b. Furthermore, sections of the flow, after being guided by the concave section 10b, also impinge on the cylinder inner wall 3a.

The surface section thus serves as a baffle plate. In this case, a flow deflection can occur in particular, which favors the development of the rotational movement, as described above. The flow of hydrogen is deflected in a plurality of directions. In the combustion chamber, a flow of the load thus performs, at least in sections, a rotational movement about at least one axis perpendicular to a longitudinal axis 8 of the at least one cylinder 3. Furthermore, the rotational movement of the flow about the at least one axis perpendicular to the longitudinal axis 8 of the at least one cylinder 3 is induced by the feeding in of hydrogen.

If, as in this case, a combustion chamber boundary is used as a surface section, no further parts need to be provided. Furthermore, the flow of hydrogen is thus provided at least in sections on an outer section of the combustion chamber 2 and is then conveyed into the interior of the combustion chamber 2 by the rotational movement, which can improve mixing with the air.

The position at which the jet 11 impinges on the concave section 10b is on a side close to the piston with respect to an outlet of the feeding device 9, thus below an outlet of the feeding device 9 in a gravitational direction when the cylinder 3 is aligned along the gravitational direction. As a result, the piston can be reliably used to generate the rotational movement about the axis perpendicular to the center axis 8.

Furthermore, the hydrogen is fed in to the combustion chamber 2 from a point in time at which the combustion chamber 2 is closed, thus, for example, the inlet 6a is closed by the application of a valve closing element to the cylinder head, and a quantity of air intended for the air/hydrogen mixture to be burned is completely in the combustion chamber 2. This means that any disruption to the tumble flow caused by incoming air can be reduced, preferably completely prevented. In addition, the hydrogen does not have to remain in the combustion chamber for too long, which reduces the risk of misfiring. However, it is also conceivable that the flow of hydrogen impinges on at least one surface section from this point in time.

The hydrogen is fed directly into the combustion chamber 2 of at least one cylinder 3. It is therefore not necessary for the air flow to form a tumble flow, which is favorable in terms of mixture formation. Furthermore, misfiring outside the combustion chamber can be prevented.

Furthermore, the flow of air performs a rotational movement about the longitudinal axis at least in sections and at least temporarily in the combustion chamber; in particular, the rotational movement about the longitudinal axis is preferably induced by the feeding in of air into the combustion chamber.

By means of the present invention, a tumble flow of at least the hydrogen can be generated even in internal combustion engines in which the feeding in of the air into the combustion chamber induces a rotational movement about the longitudinal axis in the combustion chamber, for example by design of the inlet geometry. The swirl movement of the air flow can be present at a time when the hydrogen is fed into the combustion chamber or the flow of hydrogen impinges on the at least one surface section. However, the swirl movement can also be present only before the hydrogen is fed in.

The fed in hydrogen itself performs at least in sections said rotational movement about the axis perpendicular to the longitudinal axis 8 of the at least one cylinder 3.

This rotation allows the hydrogen to mix reliably with the air. In particular, as described above, the hydrogen can flow inwards towards the center axis 8 and also downwards towards the piston 10 in a section of the combustion chamber 2 close to the cylinder head.

The angle a is between 0° and 50°. This means that the flow can be reliably deflected in a plurality of directions. The axis of the jet 11, which preferably corresponds to an axis of an outlet of the feeding device 9, impinges on the concave section 10b in the said angular range with respect to the center axis 8. Furthermore, if the feeding device is installed in a section of the combustion chamber close to the cylinder head or on the cylinder head itself in this angular range, it can be ensured that the piston is reliably used to generate the rotational movement about the axis perpendicular to the center axis 8.

As shown in FIG. 1, at least a section of the hydrogen flow is guided along the piston surface 10a and the cylinder inner wall 3a, which each represent surface sections of a combustion chamber boundary. This allows the induction of the tumble by a wall guide to be controlled more reliably. In particular, the wall guide can be provided following the impingement of the hydrogen flow on the at least one surface section. Preferably, the flow is guided along a plurality of surface sections, as in FIG. 1. Furthermore, the flow is preferably guided along a plurality of directions, as in the longitudinal section of FIG. 1, along opposite directions. In particular, the flow is guided both clockwise and counterclockwise. The flow also moves along the cylinder inner wall 3a towards the piston 10, at least in sections, and is in particular guided along this direction. In this way, the piston 10 can be used reliably to form the tumble flow.

Furthermore, the concave section 10b is provided, and the jet 11 of the fed in hydrogen impinges on the concave section 10b at least in sections. The concave section 10b can be used to form the tumble of the flow of the fed in hydrogen.

The piston surface 10a, in particular the peripheral section thereof, which is also the peripheral section 10c of the concave section 10b, comprises a rounded section. If the flow is guided along the rounded section, a rotational movement of the flow can be reliably initiated.

The internal combustion engine comprises the ignition device 7, which is configured to ignite the hydrogen/air mixture. This means that the internal combustion engine is configured for spark ignition. Good mixture homogenization is preferred, particularly in spark-ignited internal combustion engines that have a spark plug, for example.

Preferably, the tumble flow is present about the at least one axis perpendicular to the longitudinal axis 8 of the at least one cylinder at least at the time of an ignition start and further preferably at the ignition device 7. In particular, a tumble flow is present within a distance of 0.25 times the diameter d (half the radius) around the center axis 8, i.e. in a center of the combustion chamber 2.

Through the rotational movement, good mixture homogenization can be achieved at the time of ignition, wherein in particular an appropriately mixed mixture is present at the ignition device 7 in order to ensure low-emission and efficient combustion. Furthermore, the rotational movement can be used to forward the flame front in the combustion chamber.

As shown in FIG. 1, the jet 11 has a relatively small opening angle, preferably a maximum of 25°, further preferably a maximum of 20°, as does a channel in an end section of the feeding device 9. The channel in an end section of the feeding device 9, which comprises the outlet, preferably has a cylindrical geometry. A diameter of the channel of the end section of the feeding device, in particular at the outlet, is preferably at most 6 mm, further preferably at most 5 mm and is again preferably 4 mm. The jet 11 also preferably has this diameter, in particular at the outlet.

This allows momentum to be directed to the concave section 10b in a concentrated form, which improves flow deflection and subsequent mixing.

Furthermore, the hydrogen is fed in a compression stroke, preferably between 180° and 80°, more preferably between 180° and 90°, crank angle before the top dead center TDC of the piston 10 bounding the combustion chamber 2. In particular, the start of the fuel supply is in this range. However, it is also conceivable that the flow of the fuel impinges on the at least one surface section during this period.

This can also ensure that the air of the mixture is already completely in the combustion chamber, thereby reducing the effects of the inflow of air. Furthermore, the hydrogen can be given enough time to flow through the combustion chamber in order to achieve good mixing. The hydrogen also does not have to remain in the combustion chamber for too long. In addition, the internal cylinder pressure is relatively low in this angle range of the crank angle, which is why the jet 11 can impinge on the relevant surface section with high momentum.

The jet 11 preferably impinges on the concave section 10b within a distance Is from an outlet of the feeding device 9 of the hydrogen, wherein the distance is greater than or equal to 0.9 times and less than or equal to 1.2 times a stroke length of the piston bounding the combustion chamber, further preferably greater than or equal to one and less than or equal to 1.1 times the stroke length, in particular preferably greater than or equal to 1.06 times and less than or equal to 1.08 times the stroke length.

Preferably, at least one surface section, in this case the piston surface section 10a, is within this distance at the time of the aforementioned crank angle range in which the feeding process starts. This ensures that the hydrogen flow reliably impinges on the surface section.

If the distance is dimensioned too large, the flow of the fed in hydrogen may reach the surface section with low momentum due to the pressure in the combustion chamber, which opposes the flow. This distance depends on the stroke length, taking into account load movement and compaction. The relationship specified above can ensure that the hydrogen fed in reliably reaches the surface section while providing enough distance for mixing.

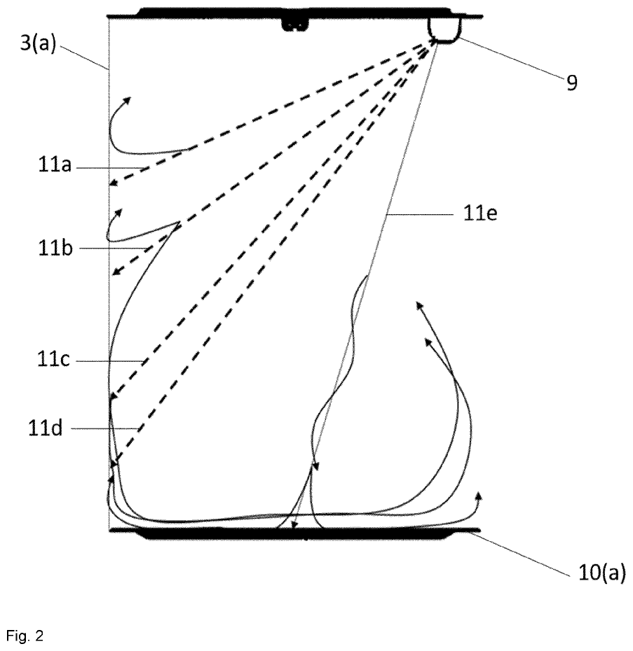

FIG. 2 shows various jets 11a to 11d (dashed) that impinge on a cylinder inner wall 3a. The cylinder inner wall 3a is rigid. The jets 11a to 11d are directed such that they each impinge on the cylinder inner wall 3a in the direction of gravity below the outlet, thus on a side close to the piston with respect to the outlet, of the feeding device 9.

The further down the impingement position is located, the greater the distance from an outlet of the feeding device. However, all impingement positions are within the maximum penetration depth of the hydrogen jet 11a to 11d supplied by the feeding device. In absolute values, the maximum penetration depth is, for example, between 140 mm and 180 mm, preferably between 145 mm and 175 mm, in particular 147 mm with a stroke length l of 136 mm and 175 mm with a stroke length l of 165 mm.

Thus, as indicated by the arrows on the respective jet, a deflection can be reliably achieved, which leads to the formation of the tumble. The flow has sections in each case with an upward movement component, in the direction of movement of the piston in the compression stroke, that is, away from the piston 10, and sections with a downward movement component, towards the piston. In this way, the flow is also deflected in different directions.

Furthermore, a jet 11e (solid) is shown which is directed towards the piston surface 10a, however would impinge on this piston surface 10a outside the distance specified above. In other words, the maximum penetration depth is not sufficient to hit the surface 10a, at least at the crank angle range specified above, in which the feeding in of the hydrogen takes place.

The jet 11a is located in a limit range of the angular range of angle a specified above, so that support of the piston during tumble formation may not occur.

Exemplary embodiments of the invention have been described above. However, this is not limited thereto.

Even if it is not shown in the Figures, a feeding device for feeding in the hydrogen may have at least one movable section which is movable, preferably linearly, with respect to the combustion chamber. Preferably, the movable section is movable with at least one component parallel to a direction of movement of a piston bounding the combustion chamber in a direction away from the piston, and more preferably, at least the movable section is preloaded along this direction. For example, a spring may be provided between a cylinder head wall and the movable section to preload the movable section, which preferably contains the outlet. The movable section can be held in a position protruding into the combustion chamber beyond the top dead center by an actuator, such as an electric motor or a hydraulic actuator. After starting, preferably after completion of the feeding process, the actuator force can be reduced, preferably completely eliminated, wherein the spring as a preload element moves the movable section away from the piston.

However, the movable section can also be provided pivotably in the combustion chamber. This means, for example, that a jet can be directed successively onto different surface sections, which promotes mixing. It is also possible to react to different pressure conditions in different power ranges and, for example, to direct the jet to a more distant surface section when the internal cylinder pressure is lower.

Only a single jet was shown in FIG. 1. In FIG. 2, the jets 11a to 11d are also each an example of a single jet that is fed in during the feeding process. However, it is also possible to provide the injection device in such a way that a plurality of jets emerge simultaneously. For this purpose, the injection device can, for example, have a plurality of outlets, which are preferably provided along a circumference, particularly preferably evenly spaced apart. Each jet preferably has the geometries specified above.

For example, a single jet can also impinge on both a piston surface and a cylinder inner wall if the jet is directed at a boundary between these two surfaces. It is also possible to direct at least one jet onto each of these sections.

It is also possible for the feeding device to have an adjustment section with which the maximum penetration depth of the jet can be regulated. This can, for example, be a variable channel section inside or at the outlet of the injection device.

The jet 11 does not have to impinge on the surface section at the center axis 8, but can also impinge on the piston surface 10a offset to it.

A tumble flow can also be induced by the injection device itself, for example by the hydrogen passing through a spiral-shaped channel in the injection device. Here too, the tumble flow is induced by the feeding in of the hydrogen.

The surface section does not necessarily have to be a boundary of the combustion chamber, but can, for example, also be a baffle plate protruding into the combustion chamber. The surface section is in particular a solid surface.

The method according to the invention is preferred above all in homogeneous operation of the internal combustion engine. However, the times at which the hydrogen is fed in can, for example, also be set such that a stratified charging operation results.

Further modifications are also included in the present invention as long as they are within the scope defined by the claims.

The features described above can be combined with each other as required.

Unless otherwise disclosed by the present disclosure, the term “at least” may also always include the corresponding entirety.

1-13. (canceled)

14. A method for operating an internal combustion engine which comprises at least one cylinder with a combustion chamber in which hydrogen fuel is combusted with air, wherein
in the combustion chamber, at least a flow of the hydrogen, at least in sections, carries out a rotational movement about at least one axis perpendicular to a longitudinal axis of the at least one cylinder, wherein
the rotational movement of the flow about the axis perpendicular to the longitudinal axis of the at least one cylinder is induced by feeding in of the hydrogen,
wherein
at least the flow of the fed in hydrogen is guided at least in sections along a cylinder inner wall.

15. The method according to claim 14, wherein the hydrogen is fed directly into the combustion chamber of the at least one cylinder.

16. The method according to claim 14, wherein the flow of air carries out a rotational movement about the longitudinal axis at least in sections and at least temporarily in the combustion chamber.

17. The method according to claim 14, wherein the flow of the hydrogen fed in impinges at least in sections on at least one surface section.

18. The method according to claim 17, wherein the jet emerging from the feeding device impinges on the surface section at a distance, wherein the distance is greater than or equal to 0.9 times and less than or equal to 1.2 times a stroke length (l) of the piston bounding the combustion chamber.

19. The method according to claim 14, wherein at least the flow of the fed in hydrogen is guided along a plurality of surface sections and/or is guided along a plurality of directions,
and/or a surface of a piston bounding the combustion chamber has a concave section.

20. The method according to claim 14, wherein the flow of hydrogen impinges on at least one surface section at least from a point in time at which the combustion chamber is closed and a quantity of air intended for the air/hydrogen mixture to be combusted is completely in the combustion chamber,
and/or the hydrogen is fed in to the combustion chamber from this point in time.

21. The method according to claim 14, wherein the internal combustion engine is spark-ignited.

22. The method according to claim 14, wherein a jet of the fed in hydrogen has an opening angle of at most 25°.

23. The method according to claim 14, wherein the flow of hydrogen impinges at least in sections and at least temporarily in a compression stroke crank angle before a top dead center of a piston bounding the combustion chamber on at least one surface section,
and/or the hydrogen is fed in at least temporarily during this period.

24. The method according to claim 14, wherein the internal combustion engine comprises a feeding device for feeding in the hydrogen, which comprises at least one movable section which is movable with respect to the combustion chamber.

25. A control device configured to carry out the method according to claim 14 on an internal combustion engine.

26. An internal combustion engine with a control device according to claim 25.

27. An internal combustion engine configured to be operable according to the method according to claim 14, which comprises
at least one cylinder with a combustion chamber in which hydrogen fuel can be combusted with air;
a piston which bounds the combustion chamber; and
a feeding device for feeding in hydrogen to the combustion chamber such that a jet emerging from the feeding device impinges on a piston surface facing the combustion chamber and a flow of hydrogen is guided along the piston surface,
wherein the piston surface has a deflection section which continues to deflect hydrogen flow guided along the piston surface in a guided manner towards a cylinder inner wall with a movement component in a direction of a cylinder head of the internal combustion engine.

28. A program that, when executed by a computer coupled to an internal combustion engine, causes the computer to perform the method according to claim 14.

29. A computer-readable storage medium on which the program of claim 28 is stored.
